(19) United States
(12) Patent Application Publication
(10) Pub. No.: US 2014/0089356 A1
(43) Pub. Date: Mar. 27, 2014

(54) DATA STORAGE DEVICE AND OPERATING METHOD THEREOF

(71) Applicant: SK hynix Inc., Gyeonggi-do (KR)

(72) Inventor: Joo-Woon LEE, Gyeonggi-do (KR)

(73) Assignee: SK hynix Inc., Gyeonggi-do (KR)

(21) Appl. No.: 14/036,093

(22) Filed: Sep. 25, 2013

(30) Foreign Application Priority Data
Sep. 25, 2012 (KR) 10-2012-0106407

(51) Int. Cl. G06F 17/30

(52) U.S. Cl. CPC G06F 17/3007
USPC 707/821

(57) ABSTRACT

A data storage device may include a logical space suitable for storing a file and a slack space suitable for storing a meta data corresponding to the file.

### CROSS-REFERENCE TO RELATED APPLICATIONS

The present application claims priority under 35 U.S.C. §119(a) from Korean Patent Application No. 10-2012-0106407 filed on Sep. 25, 2012, in the Korean Intellectual Property Office, which is incorporated herein by reference in its entirety.

### BACKGROUND

1. Technical Field

Embodiments of the present invention relate to a data storage device and an operating method thereof and more particularly to a data storage device that stores a meta data for a file and an operating method thereof.

2. Related Art

If power supply or data communication with a system is abnormally cut off while a data storage device is performing an operation to a file, such a file may be corrupted or damaged.

The data storage device according to a prior art does not have a solution to recover the corrupted or damaged file due to the abnormal cut-off.

### SUMMARY

Various embodiments are directed to a data storage device that stores a meta data corresponding to a file and operating method thereof.

In an embodiment, a data storage device may include a logical space suitable for storing a file and a slack space suitable for storing a meta data corresponding to the file.

In an embodiment, a system may include a data storage device and a controller suitable for controlling the data storage device. The data storage device may include a logical space suitable for storing a file and a slack space suitable for storing a meta data corresponding to the file.

In an embodiment, an operating method of a data storage device may include beginning an operation to a file that is stored in a logical space and storing a meta data corresponding to the file in a slack space. The data storage device may include the logical space suitable for storing the file and the slack space suitable for storing the meta data.

In an embodiment, the operating method of a data storage device may further include enabling a flag that is included in the meta data.

In an embodiment, the operating method of a data storage device may further include finishing the operation for the file; and disabling the flag.

In an embodiment, the operating method of a data storage device may further include rebooting the data storage device; and determining whether or not to perform a post process for the file with reference to the flag.

In an embodiment, the operating method of a data storage device may further include rebooting the data storage device; identifying the meta data having the enabled flag; performing a post processing for the file corresponding to the meta data with the enabled flag; and disabling the enabled flag.

In an embodiment, the performing the post process may include identifying location of the file in the logical space based on the identified meta data; and modifying or removing the file, wherein the meta data includes the information on location of the file in the logical space.

In an embodiment, the performing a post process may include identifying an application program that caused the operation to the file corresponding to the enabled flag; and allowing the identified application program to perform a post process for the file, wherein the meta data includes information on the application program.

In an embodiment, a system may include a non-volatile storage and a controller suitable for finishing an operation to a data that is interrupted, wherein the non-volatile storage includes a first storage suitable for storing the data and a second storage suitable for storing a flag that represents current status of the operation to the data.

### BRIEF DESCRIPTION OF THE DRAWINGS

FIG. 1 is a block diagram illustrating a data storage device and a system including the same in accordance with an embodiment of the present invention.

FIG. 2 is a diagram illustrating a data structure of a meta data in accordance with an embodiment of the present invention.

FIG. 3 is a flow chart illustrating an operation of file generation in accordance with an embodiment of the present invention.

FIG. 4 is a flow chart illustrating an operation of a post process for a data storage device in accordance with the embodiments of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like numbered parts in the various figures and embodiments of the present invention.

The drawings are not necessarily to scale and in some instances, proportions may have been exaggerated in order to clearly illustrate features of the embodiments. It is also noted that in this specification, “connected/coupled” refers to one component not only directly coupling another component but also indirectly coupling another component through an intermediate component. In addition, a singular form may include a plural form as long as it is not specifically mentioned in a sentence.

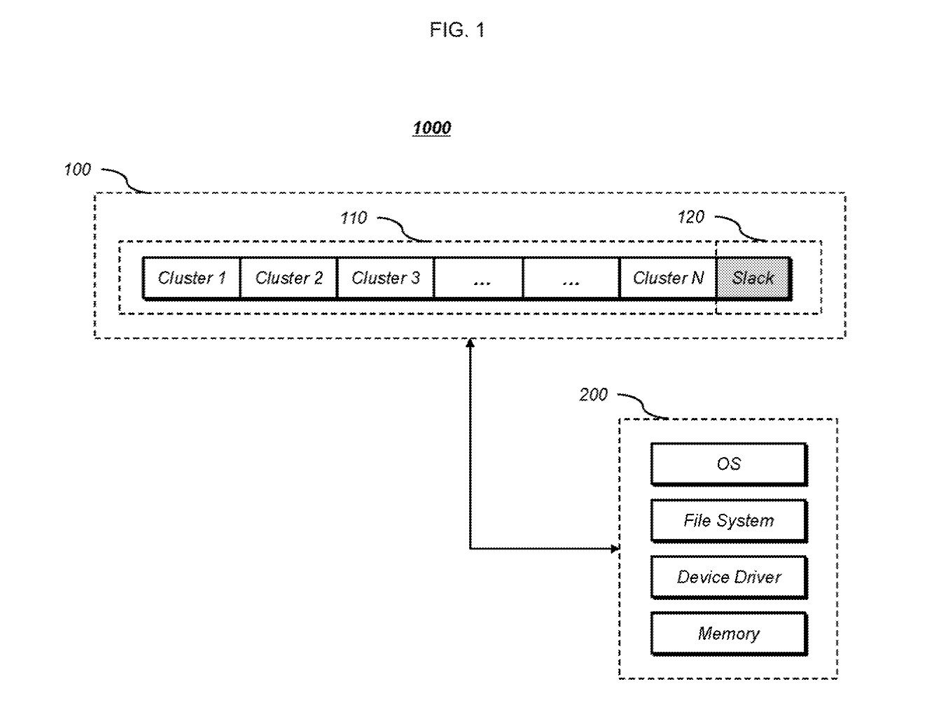

FIG. 1 is a block diagram illustrating a data storage device and a system including the same in accordance with an embodiment of the present invention.

The system 1000 may include a data storage device 100 and a controller 200 for controlling the data storage device 100.

The controller 200 may include an operating system, a file system, a device driver, a memory device and so forth which may be embodied in the form of a hardware and/or software.

The controller 200 may control operations of the data storage device 100 such as formatting the data storage device 100, storing data in the data storage device 100 and modifying or removing data stored in the data storage device 100.

The data may include a file and a directory.

There are various kinds of file systems like File Allocation Table (FAT), New Technology File System (NTFS), EXTended file system (EXT) and etc. The file system may depend on a system design. In the following, the embodiments are disclosed with reference to the FAT file system as an example.

The data storage device 100 may also be embodied with various kinds of storage media. For example, the data storage device 100 may include a disk drive, a NAND flash memory device or other kinds of non-volatile memory devices.

Before use of the data storage device 100, storage area of the data storage device 100 may be formatted. The format may represent an operation for allocating a logical space, which the file system understands and uses, with respect to a physical space of the storage area.

After format to the storage area, a logical space 110 including a plurality of clusters is generated in the data storage device 100. The format to the storage area may leave a remainder or a slack space 120 of the data storage device 100 that is not allocated as the logical space 110. The size of the slack space 120 may vary according to the size of a sector or a cluster. In an example where a physical storage capacity of the data storage device 100 is 1002 Kbyte and a size of a cluster is 4 Kbyte, 250 clusters may be allocated in the logical space 110 and the remaining area or the slack space 120 may be 2 Kbyte.

The file system does not use the slack space 120 but the controller 200 may still be capable of accessing the slack space 120 by using device drivers. Since operations of the file system or the device drivers are known, the detailed explanations thereof are omitted.

In an embodiment, the controller 200 may store a meta data in the slack space 120 of the data storage device 100. The meta data may include information on the data, which may be a file as disclosed in the example, and may be used in a post process for the file.

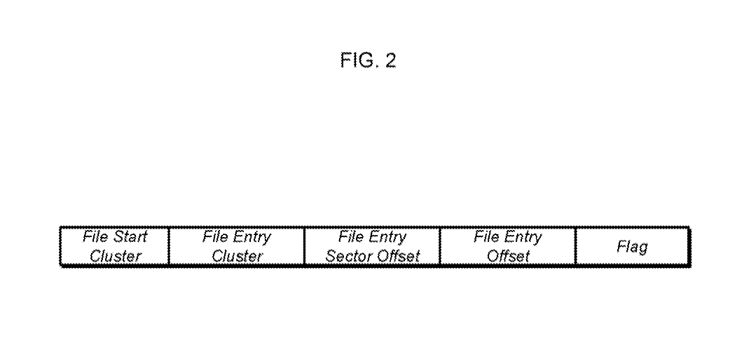

FIG. 2 is a diagram illustrating a data structure of a meta data in accordance with an embodiment of the present invention.

The meta data may be generated using data such as a file entry, a file handle and so forth, which may be required for the post process. The functions of the file entry and the file handle may vary according to the file system but the basic functions thereof are known. In the following the file handle and the file entry in the FAT file system are disclosed.

As disclosed above, the controller 200 may control operations of the data storage device 100 such as storing data in the data storage device 100 and modifying or removing data stored in the data storage device 100. Before those operations, the controller 200 may open a the and set a file handle and may store data structure on the file in the file handle. The file handle may represent information that the controller 200 assigns temporarily to the file when it is opened. The controller 200 uses the file handle internally when accessing the file. The file handle may be destroyed by the controller 200 when the file is closed.

The data structure may include an operation mode information such as generation, read and write of a file; an offset information that represents a current location in the file; a starting cluster information that represents a cluster where the file starts; a partition information where the file is included; a file handle value information that represents the file to be opened; a start cluster information of a directory that includes the file; a file entry offset information of a sector that includes a file entry; a sector offset information of a sector that includes the file entry; a cluster information of a cluster that includes the file entry; a size information of the cluster; a handle type information that represents whether the file handle is for a file or a directory; a size information of the file and etc.

The file entry is information that includes a file name, file attributes and a file location and is stored independently from the corresponding file.

In an embodiment the meta data may further include information on location of a file in the logical space that may be obtained by referring the file handle and the file entry. File start cluster information, file entry cluster information, file entry sector offset information, file entry offset information illustrated in FIG. 2 correspond to the information on location of a file.

File start cluster information represents a first cluster among clusters allocated for a file. In the FAT file system, since the data is structured as a linked list, the whole clusters allocated for a file may be traversed with the first cluster. File entry cluster information represents a cluster where a file entry of the corresponding file is located. File entry sector offset information represents location of a file entry in a sector including the file entry.

In an embodiment, the meta data may further include a flag. The enabled flag may represent on-going operation of the controller 200 to the corresponding file, and the disabled flag may represent completion of operation of the controller 200 for the corresponding file.

If power supply or data communication with a system or the controller 200 is abnormally cut off while the data storage device 100 is performing operation to data or a file, the flag in the meta data corresponding to the file is kept enabled. Therefore, enablement or disablement of the flag in the meta data stored in the slack space 120 at the time of comeback from the abnormal cut-off may show whether the controller 200 was in the middle of processing a file at the time of the abnormal cut-off.

When power is turned on again or the data storage device 100 is reconnected to the controller 200, the flag of the meta data stored in the slack space 120 may be checked by the controller 200 to perform a post process. The post process may include recovering a file.

In the FIG. 2, for example, each information field of the meta data may occupy 4 byte and thus the meta data may occupy 20 bytes.

In an embodiment, the meta data may be stored in the slack space 120. The number of meta data that can be stored in the slack space 120 may vary according to the sizes of the slack space 120 and the meta data.

In an embodiment, the meta data corresponding to a file being currently processed may be stored in the slack space 120. When the process to the file finishes, the flag of the corresponding meta data may be disabled. The meta data with disabled flag may be removed from the slack space 120.

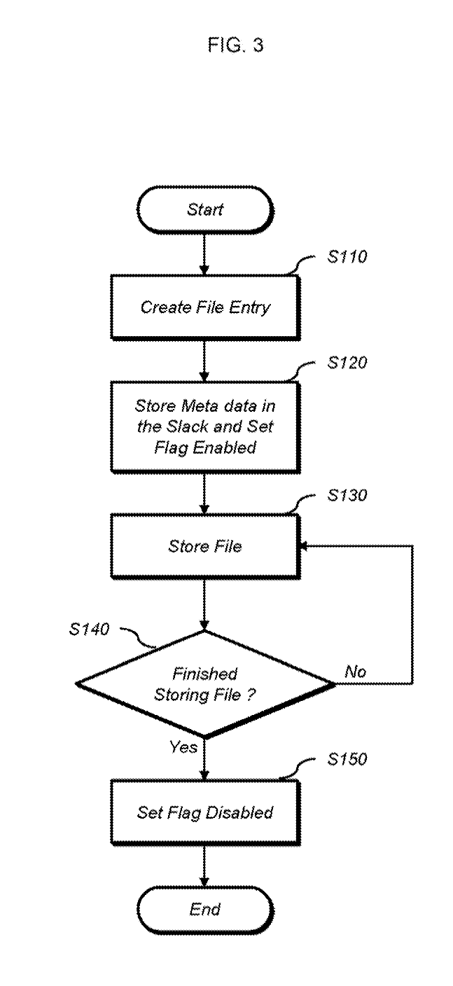

FIG. 3 is a flow chart illustrating operation of file generation in accordance with an embodiment of the present invention.

When storing a file in a data storage device 100, a file system in the controller 200 may generate a file entry for the file to be stored at step S110. A file handle corresponding to the file to be stored may also be generated at the step S110.

As aforementioned, the file entry may include information on a file name, file attributes and a file location. Information that may be included in the file entry may vary according to the file system and the file entry may be stored in a region different from a region where the file is stored.

The controller 200 may refer to the file entry and the file handle generated at the step S110 to generate a meta data as disclosed in FIG. 2 in step S120. The meta data may be stored in a slack space 120. The flag of the meta data may be enabled.

The controller 200 stores the file in the logical space 110 at step S130.

The controller 200 checks whether storing the file has finished at step S140.

If the storing has finished, the controller 200 disables the flag, in the meta data stored in the slack space 120 at step S150.

Though FIG. 3 illustrates operation of storing a file in a data storage device 100, a same process may be applied for modification or removal of the file, except that the controller 200 may have stored the file to be modified or removed, and the corresponding file handle and the corresponding file entry for the stored file. The controller 200 therefore may generate a meta data with reference to the file handle and the file entry corresponding to the stored file to be modified or removed.

The generated meta data may be stored in the slack space 120 of the data storage device 100 and the flag of the meta data is enabled.

After finishing modification or removal of the file, the controller 200 may disabled the flag in the meta data. The meta data with the disabled flag may be removed from the slack space 120.

If power supply or data communication with the controller 200 is abnormally cut off while the data storage device 100 is performing operation to data or the file, the flag, which is enabled at step S120, is kept enabled in the slack space 120.

In an embodiment, when the power supply is resumed or the data storage device 100 is reconnected to the controller 200, the controller 200 may refer to the slack space 120 to find the meta data with enabled flag to perform post process for the corresponding file. The post process may include recovering the corresponding file.

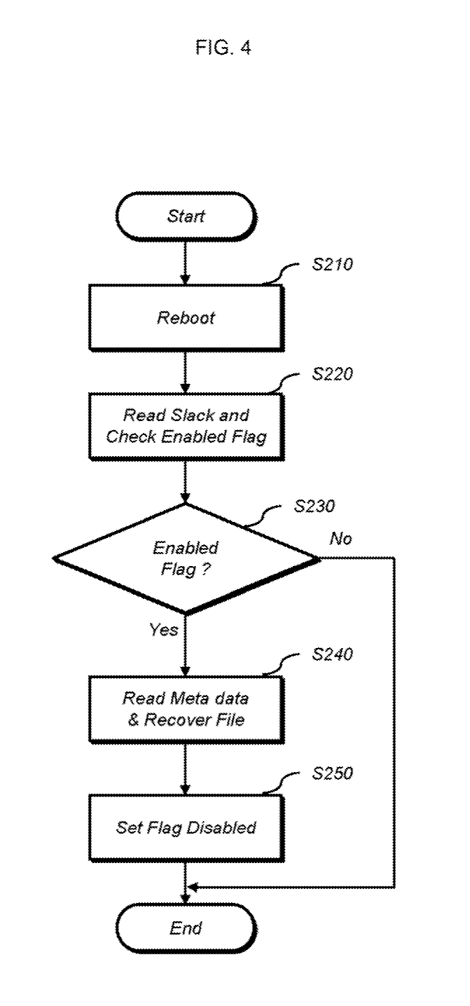

FIG. 4 is a flow chart illustrating operation of a post process for a data storage device in accordance with the embodiments of the present invention.

If power supply is resumed or the data storage device 100 is reconnected to the controller 200 after comeback from the abnormal cut-off, the data storage device 100 and/or the controller 200 may reboot at step S210.

The rebooting may be understood as the data storage device 100 being mounted on the controller 200.

After mounting, the controller 200 may read the slack space 120 to check whether there is a meta data with an enabled flag at step S220 and at step S230.

The controller 200 does not need to perform a post process for a file corresponding to the meta data with a disabled flag.

The controller 200 may perform a post process for a file corresponding to the meta data with an enabled flag.

The kinds of post process may vary according to embodiments. For example, the controller 200 may remove the corresponding file. For this, the controller 200 may refer to the file start cluster information in the meta data illustrated in FIG. 2 and may remove all dusters from the file start duster to the last cluster for the corresponding file. After removing the file, the controller 200 may find and remove the corresponding file entry by referring the file entry cluster information, file entry sector offset information, and file entry offset information illustrated in FIG. 2. Removal of the file entry makes the file system of the controller 200 to acknowledge removal of the corresponding file from the data storage device 100.

For example, the controller 200 may finish storing a file corresponding to the meta data with enabled flag. The file corresponding to the meta data with enabled flag that is read by the controller 200 at the step S230 shows that power supply or data communication with the controller 200 is abnormally cut off while the data storage device 100 is performing operation to the file before rebooting at step S210. For this, the controller 200 may search the last cluster of the file based on the file start cluster information and the controller 200 may allocate a new cluster after the last cluster and designate End of File (EOF) in the new cluster.

In an embodiment, the meta data may further include information on an application program that provides to the controller 200 a command for performing operation to the file. In the operation of the post process for the data storage device 100 illustrated in FIG. 4, the controller 200 may allow the application program to participate in and/or perform the post process for the file based on the information about the application program.

The specific operations between the controller 200 and the application program may be embodied in various ways by an ordinary skill in the art by referring to the present disclosure and other known arts.

After finishing the post process, the controller 200 may disable the flag in the meta data at step S250. The controller 200 may remove the meta data after disabling the flag thereof.

Though FIG. 4 illustrates an embodiment for a meta data, it is obvious to an ordinary skill in the art that FIG. 4 may be expanded for an embodiment with a plurality of meta data each having an flag representing on-going operation or completion of operation of the controller 200 for the corresponding file.

Although various embodiments have been described for illustrative purposes, it will be apparent to those skilled in the art that various changes and modifications may be made without departing from the spirit and scope of the invention as defined in the following claims.

What is claimed is:

1. A data storage device comprising:
a logical space suitable for storing a file; and
a slack space suitable for storing a meta data corresponding to the file.

2. The data storage device of claim 1, wherein the meta data comprises a flag that represents status of an operation of the data storage device to the file.

3. The data storage device of claim 2, wherein the flag is enabled when the operation begins, and the flag is disabled when the operation finishes.

4. The data storage device of claim 1, wherein the meta data includes information on location of the file in the logical space.

5. The data storage device of claim 3, wherein the meta data includes information on an application program that caused the operation to the file corresponding to the enabled flag.

6. A system comprising:
a data storage device; and
a controller suitable for controlling the data storage device, wherein the data storage device includes
a logical space suitable for storing a file; and
a slack space suitable for storing a meta data corresponding to the file.

7. The system of claim 6, wherein the meta data comprise a flag that represents status of an operation of the data storage device to the file.

8. The system of claim 7, wherein the flag is enabled when the operation begins, and the flag is disabled when the operation finishes.

9. The system of claim 6, wherein the meta data includes information on a location of the file in the logical space.

10. The system of claim 7, wherein the meta data includes information on an application program that caused the operation to the file corresponding to the enabled flag.

11. The system of claim 6, wherein the controller performs a post process for the file by referring to the meta data.

12. The system of claim 7, wherein the controller performs a post process for the file by referring to the flag.

13. A system comprising:
a non-volatile storage; and
a controller suitable for finishing an operation to a data that is interrupted, wherein
the non-volatile storage includes
a first storage suitable for storing the data; and
a second storage suitable for storing a flag that represents current status of the operation to the data.

14. The system of claim 13, wherein the flag is enabled when the operation begins, and the flag is disabled when the operation finishes.

15. The system of claim 13, wherein the controller performs a post process for the data by referring to the flag.

16. The system of claim 15, wherein the controller disables enabled flag after finishing the post process.

17. The system of claim 15, wherein the second storage further stores information on an application program that caused the operation to the data corresponding to the enabled flag.

18. The system of claim 17, wherein the controller allows the application program perform the post process for the data.

19. The system of claim of 15, wherein the second storage further stores information on location of the data in the first storage.

20. The system of claim 19, wherein the controller modifies or removes the data during the post process.
